(19) United States
(12) Patent Application Publication
(10) Pub. No.: US 2025/0351165 A1
(43) Pub. Date: Nov. 13, 2025

(54) METHOD, MESH NETWORK CONTROLLER AND TOPOLOGY CENTER DEVICE FOR PERFORMING CHANNEL ALLOCATION IN MESH NETWORK

(71) Applicant: Realtek Semiconductor Corp., HsinChu (TW)

(72) Inventors: Kuang-Lung Yu, HsinChu (TW); Tsung-Han Lei, HsinChu (TW)

(73) Assignee: Realtek Semiconductor Corp., HsinChu (TW)

(21) Appl. No.: 19/194,023

(22) Filed: Apr. 30, 2025

(30) Foreign Application Priority Data
May 7, 2024 (TW) 113116779

(51) Int. Cl. H04W 72/542; H04W 72/04; H04W 84/18

(52) U.S. Cl. CPC H04W 72/542; H04W 72/04; H04W 84/18

(57) ABSTRACT

A method, a mesh network controller and a topology center device for performing channel allocation in a mesh network are provided. The method includes: utilizing the mesh network controller to send a channel scan request to multiple mesh network agent devices; utilizing the multiple mesh network agent devices to detect wireless communication information in response to the channel scan request in order to generate multiple channel scan reports, respectively; utilizing the mesh network controller to receive the multiple channel scan reports from the multiple mesh network agent devices, respectively; and utilizing the mesh network controller to send corresponding channel selection requests to the multiple mesh network agent devices according to the multiple channel scan reports, in order to make the multiple mesh network agent devices select corresponding wireless communication channels according to the corresponding channel selection requests, respectively.

### BACKGROUND OF THE INVENTION

### 1. Field of the Invention

The present invention is related to mesh networks, and more particularly, to a method, a mesh network controller and a topology center device for performing channel allocation in a mesh network.

### 2. Description of the Prior Art

Related art mesh network (e.g. EasyMesh™) manufacturers typically set wireless communication of respective devices in the mesh on a same channel, and make these devices contend for resources (e.g. bandwidths) of this channel, resulting in wireless communication performance of these devices being hard to be optimized. More particularly, when a back-haul network of the mesh network is built with wireless communication, the back-haul network and a front-haul network need to be set on a same frequency band and a same channel, in order to allow the back-haul network and the front-haul network to exchange mesh network messages with each other.

Thus, there is a need for a novel method and an associated architecture, which can make access points within the mesh network have maximized bandwidth usage rates after being linked.

### SUMMARY OF THE INVENTION

An objective of the present invention is to provide a method, a mesh network controller and a topology center device for performing channel allocation in a mesh network, in order to automatically separate channels of respective mesh network access points via a mechanism of automatically selecting channels of the mesh network access points, thereby improving an overall performance of the mesh Network.

At least one embodiment of the present invention provides a method for performing channel allocation in a mesh network, where the mesh network comprises a mesh network controller and multiple mesh network agent devices. The method comprises: utilizing the mesh network controller to send a channel scan request to the multiple mesh network agent devices; utilizing the multiple mesh network agent devices to detect wireless communication information in response to the channel scan request in order to generate multiple channel scan reports, respectively; utilizing the mesh network controller to receive the multiple channel scan reports from the multiple mesh network agent devices, respectively; and utilizing the mesh network controller to send corresponding channel selection requests to the multiple mesh network agent devices according to the multiple channel scan reports, in order to make the multiple mesh network agent devices select corresponding wireless communication channels according to the corresponding channel selection requests.

At least one embodiment of the present invention provides a mesh network controller for performing channel allocation in a mesh network, where the mesh network comprises the mesh network controller and multiple mesh network agent devices. The mesh network controller comprises a read-only memory (ROM) and a processing circuit, where the processing circuit is coupled to the ROM. The ROM is configured to store a program code, and the processing circuit is configured to execute a channel selection procedure of the mesh network according to the program code. The channel selection procedure comprises: the processing circuit sends a channel scan request to the multiple mesh network agent devices, wherein the multiple mesh network agent devices detect wireless communication information in response to the channel scan request in order to generate multiple channel scan reports, respectively; the processing circuit receives the multiple channel scan reports from the multiple mesh network agent devices, respectively; and the processing circuit sends corresponding channel selection requests to the multiple mesh network agent devices according to the multiple channel scan reports, in order to make the multiple mesh network agent devices select corresponding wireless communication channels according to the corresponding channel selection requests, respectively.

At least one embodiment of the present invention provides a topology center device for performing channel allocation in a mesh network, where the mesh network comprises a mesh network controller and multiple mesh network agent devices, and the topology center device is one of the mesh network agent devices. The topology center device comprises a ROM and a processing circuit, where the processing circuit is coupled to the ROM. The ROM is configured to store a program code, and the processing circuit is configured to execute a channel selection procedure of the mesh network according to the program code. The channel selection procedure comprises: the processing circuit receives a channel scan request from the mesh network controller, and detects wireless communication information in response to the channel scan request in order to generate a channel scan report, wherein when the mesh network controller determines that the topology center device is located at a topology center of the mesh network according to the channel scan report from the topology center device, the mesh network controller sends a first channel selection request to the topology center device; and the processing circuit selects an optimized channel from multiple candidate channels as a wireless communication channel of the topology center device in response to the first channel selection request, and generates a channel selection report according to the optimized channel, wherein the mesh network controller receives the channel selection report from the topology center device to send a second channel selection request to the multiple mesh network agent devices other than the topology center device according to the channel selection report, in order to make the multiple mesh network agent devices other than the topology center device select channels other than the optimized channel from the multiple candidate channels.

The method, the mesh network controller and the topology center device of the embodiments of the present invention can separate the channels used by respective access points in the mesh network, thereby maximizing utilization of bandwidth of the wireless network. Furthermore, the embodiments of the present invention will not significantly increase additional costs. Thus, the present invention can solve the problems of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a mesh network according to an embodiment of the present invention.

FIG. 2 is a diagram illustrating any access point device in the mesh network shown in FIG. 1 according to an embodiment of the present invention.

FIG. 3 is a diagram illustrating a working flow of a method for performing channel allocation in a mesh network according to an embodiment of the present invention.

FIG. 4 is a diagram illustrating related details of the method shown in FIG. 3 according to an embodiment of the present invention.

FIG. 5 is a diagram illustrating related details of the method shown in FIG. 3 according to another embodiment of the present invention.

### DETAILED DESCRIPTION

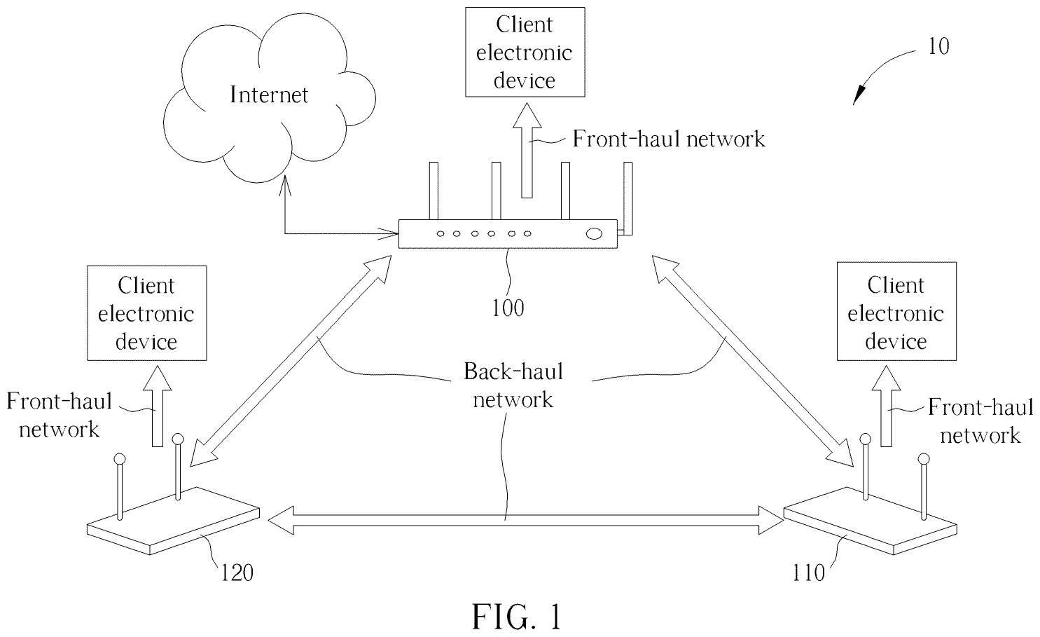

FIG. 1 is a diagram illustrating a mesh network 10 according to an embodiment of the present invention, where the mesh network 10 may comprise a mesh network controller 100 and multiple mesh network agent devices such as 110 and 120. The number of mesh network agent devices supported by the present invention is not limited to the two devices shown in this embodiment. In this embodiment, each of the mesh network controller 100 and the mesh network agent devices 110 and 120 may function as an access point (AP) device to provide a wireless network (e.g., Wi-Fi wireless network) for client electronic devices equipped with wireless network connectivity functions (e.g. mobile phones, computers, wearable electronic devices equipped with Wi-Fi connectivity). In particular, communication between the mesh network controller 100 and the mesh network agent devices 110 and 120 may be performed via a back-haul network, and the client electronic devices mentioned above may communicate with any AP device in the mesh network 10 (e.g. any of the mesh network controller 100 and the mesh network agent devices 110 and 120) via a front-haul network. For example, when a client electronic device intends to download data from the internet through the mesh network 10, the mesh network controller 100 can obtain the data from the internet and transmit the data to an AP device accessed by the client electronic device (e.g. the nearest AP device to the client electronic device) via the back-haul network, allowing the client electronic device to obtain the data from the AP device via the front-haul network. In another example, when a client electronic device intends to upload data to the internet through the mesh network 10, the client electronic device can transmit the data to any AP device in the mesh network 10 (e.g. the nearest AP device to the client electronic device) via the front-haul network, and the AP device can then send the data to the mesh network controller 100 via the back-haul network, allowing the mesh network controller 100 to upload the data to the internet.

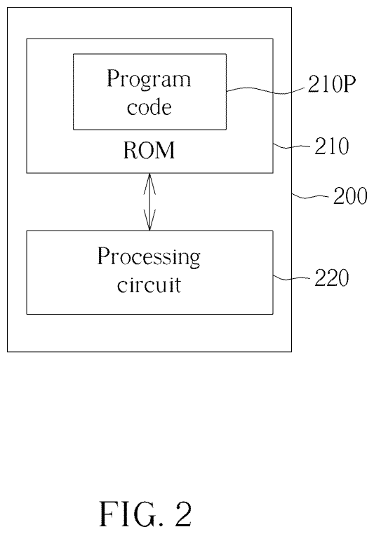

FIG. 2 is a diagram illustrating any AP device (referred to as an AP device 200) in the mesh network 10 (e.g. any of the mesh network controller 100 and the mesh network agent devices 110 and 120) shown in FIG. 1 according to an embodiment of the present invention. As shown in FIG. 2, the AP device 200 may comprise a read-only memory (ROM) 210 and a processing circuit 220, where the processing circuit 220 is coupled to the ROM 210. More particularly, the ROM 210 is configured to store a program code 210P (e.g. a program code corresponding to a channel selection procedure of the mesh network 10), and the processing circuit 220 may control operations of the AP device 200 according to the program code 210P, especially by executing the channel selection procedure of the mesh network 10 according to the program code 210P.

In some embodiments, the mesh network controller 100 shown in FIG. 1 may be implemented by the AP device 200 shown in FIG. 2, where the processing circuit 220 within the mesh network controller 100 may control operations of the mesh network controller 100 (e.g. operations of the mesh network controller 100 involved in the channel selection procedure mentioned above) according to the program code 210P. In particular, the processing circuit 220 (e.g. the mesh network controller 100 comprising the processing circuit 220) may send a channel scan request to the mesh network agent devices 110 and 120, where the mesh network agent devices 110 and 120 may detect wireless communication information in response to the channel scan request in order to generate multiple channel scan reports, respectively. Then, the processing circuit 220 may receive the multiple channel scan reports from the mesh network agent devices 110 and 120, respectively, and the processing circuit 220 may send corresponding channel selection requests to the mesh network agent devices 110 and 120 according to the multiple channel scan reports, in order to make the mesh network agent devices 110 and 120 select corresponding wireless communication channels according to the corresponding channel selection requests.

In some embodiments, any of the mesh network agent devices 110 and 120 shown in FIG. 1 may be selected as a topology center device by the mesh network controller 100, where the topology center device may be implemented by the AP device 200 shown in FIG. 2, and the processing circuit 220 within the topology center device may control operations of the topology center device (e.g. operations of the topology center device involved in the channel selection procedure mentioned above) according to the program code 210P. In particular, the processing circuit 220 (e.g. the topology center device comprising the processing circuit 220) may receive a channel scan request from the mesh network controller 100, and detect wireless communication information in response to the channel scan request, in order to generate a channel scan report. When the mesh network controller 100 determines that the topology center device is located at a topology center of the mesh network 10 according to the channel scan report from the topology center device, the mesh network controller 100 may send a first channel selection request to the topology center device. Then, the topology center device may select an optimized channel from multiple candidate channels as a wireless communication channel of the topology center device in response to the first channel selection request, and generate a channel selection report according to the optimized channel. The mesh network controller 100 may receive the channel selection report from the topology center device, and send a second channel selection request to the mesh network agent devices other than the topology center device according to the channel selection report, in order to make the multiple mesh network agent devices other than the topology center device select channels other than the optimized channel from the multiple candidate channels. For example, when the mesh network agent device 110 is selected as the topology center device, the mesh network agent device 110 may select the optimized channel, and the mesh network controller 100 may send the second channel selection request to the mesh network agent device 120 according to the channel selection report from the mesh network agent device 110, in order to make the mesh network agent device 120 select a channel other than the optimized channel. When the mesh network agent device 120 is selected as the topology center device, the mesh network agent device 120 may select the optimized channel, and the mesh network controller 100 may send the second channel selection request to the mesh network agent device 110 according to the channel selection report from mesh network agent device 120, in order to make the mesh network agent device 110 select a channel other than the optimized channel.

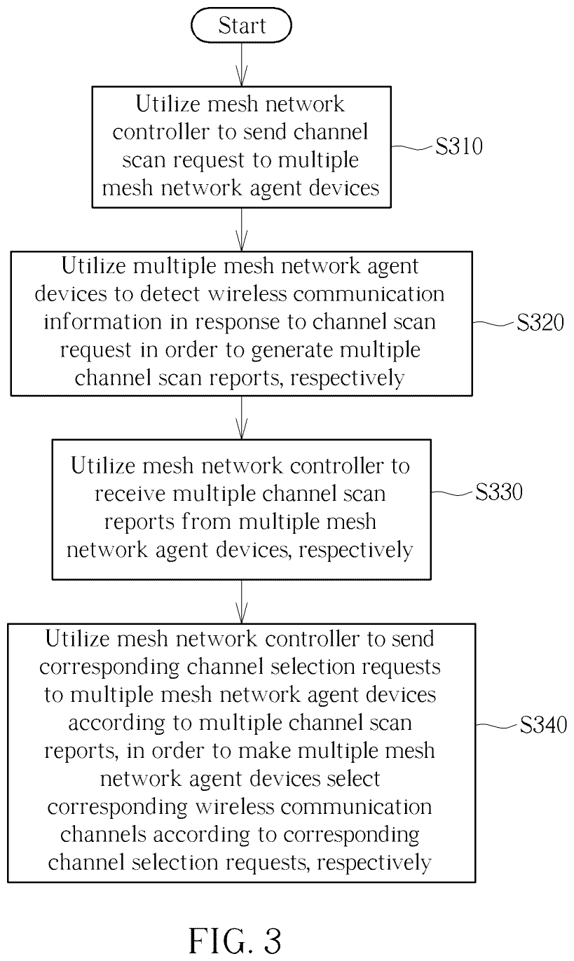

FIG. 3 is a diagram illustrating a working flow of a method for performing channel allocation in a mesh network (e.g. the mesh network 10 formed by the mesh network controller 100 and the mesh network agent devices 110 and 120 shown in FIG. 1) according to an embodiment of the present invention. It should be noted that the working flow shown in FIG. 3 is for illustrative purposes only, and is not meant to be a limitation of the present invention. For example, one or more steps may be added, deleted or modified in the working flow shown in FIG. 3. In addition, if a same result can be obtained, these steps do not have to be executed in the exact order shown in FIG. 3.

In Step S310, the mesh network may utilize a mesh network controller to send a channel scan request to multiple mesh network agent devices.

In Step S320, the mesh network may utilize the multiple mesh network agent devices to detect wireless communication information in response to the channel scan request in order to generate multiple channel scan reports, respectively.

In Step S330, the mesh network may utilize the mesh network controller to receive the multiple channel scan reports from the multiple mesh network agent devices, respectively.

In Step S340, the mesh network may utilize the mesh network controller to send corresponding channel selection requests to the multiple mesh network agent devices according to the multiple channel scan reports, in order to make the multiple mesh network agent devices select corresponding wireless communication channels according to the corresponding channel selection requests, respectively.

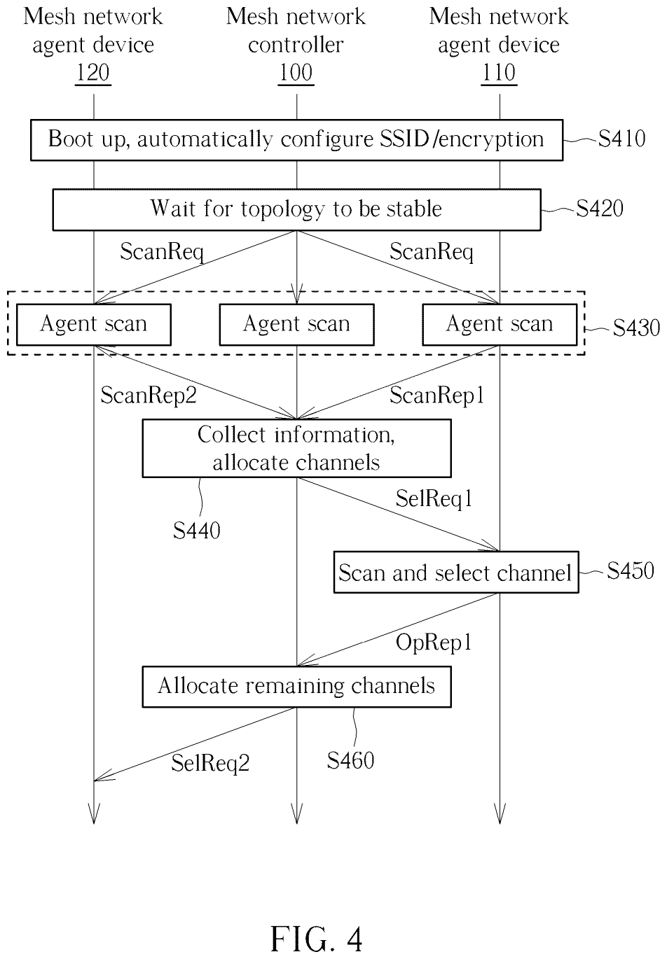

FIG. 4 is a diagram illustrating related details of the method shown in FIG. 3 according to an embodiment of the present invention. More particularly, the embodiment of FIG. 4 illustrates communication and corresponding operations between AP devices (e.g. the mesh network controller 100 and the mesh network agent devices 110 and 120) in the mesh network 10.

In Step S410, a user may turn on the power of the mesh network controller 100 and the mesh network agent devices 110 and 120, to make the mesh network controller 100 and the mesh network agent devices 110 and 120 be linked with each other to form the mesh network 10. After the mesh network controller 100 and the mesh network agent devices 110 and 120 are booted up, the mesh network controller 100 and the mesh network agent devices 110 and 120 may automatically configure their respective service set identifiers (SSIDs) and encryption settings (labeled “Boot up, automatically configure SSID/encryption” for brevity).

In Step S420, the mesh network controller 100 and the mesh network agent devices 110 and 120 may wait for a period of time to stabilize topology of the mesh network 10 (labeled “Wait for topology to be stable” for brevity). After the topology is stabilized, the mesh network controller 100 may send a channel scan request ScanReq to the mesh network agent devices 110 and 120.

In step S430, each of the mesh network agent devices 110 and 120 may detect wireless communication information (e.g. scanning current status of the front-haul network in the air and current status of surrounding front-haul networks) in response to the channel scanning request ScanReq, in order to generate multiple channel scan reports, respectively. Furthermore, the mesh network controller 100 may start detecting wireless communication information (e.g., scanning current status of the front-haul network in the air and current status of surrounding front-haul networks) after sending the channel scanning request ScanReq, in order to generate a channel scan report. For brevity, the operations of detecting wireless communication information mentioned above are annotated as “Agent scan” in FIG. 4. In this embodiment, the wireless communication information mentioned above may comprise received signal strength indicator (RSSI) information and/or channel loads, or any other available information in the air.

In this embodiment, the RSSI information within the channel scan report generated by each mesh network agent device of the mesh network agent device 110 and 120 may comprise multiple RSSIs, where these RSSIs may comprise RSSIs between this mesh network agent device and other mesh network agent devices, as well as RSSIs between this mesh network agent device and the mesh network controller 100. In addition, the channel scan report generated by the mesh network controller 100 may include multiple RSSIs, where these RSSIs may comprise an RSSI between the mesh network controller 100 and the mesh network agent device 110, as well as an RSSI between the mesh network controller 100 and the mesh network agent device 120. For example, the channel scan report generated by the mesh network controller 100 may record the RSSI of the front-haul network between the mesh network controller 100 and the mesh network agent device 110, as well as the RSSI of the front-haul network between the mesh network controller 100 and the mesh network agent device 120. The channel scan report generated by the mesh network agent device 110 may record the RSSI of the front-haul network between mesh network agent device 110 and the mesh network controller 100, as well as the RSSI of the front-haul network between the mesh network agent device 110 and the mesh network agent device 120. The channel scan report generated by the mesh network agent device 120 may record the RSSI of the front-haul network between the mesh network agent device 120 and the mesh network controller 100, as well as the RSSI of the front-haul network between the mesh network agent device 120 and the mesh network agent device 110.

In step S440, the mesh network controller 100 may receive the channel scan reports from the mesh network agent devices 110 and 120., respectively (e.g., receiving a channel scan report ScanRep1 from the mesh network agent device 110 and receiving a channel scan report ScanRep2 from the mesh network agent device 120), in order to collect the information detected by respective access point devices, thereby allowing the mesh network controller 100 to determine which channels are available (e.g. to identify multiple candidate channels). For brevity, the aforementioned operation is labeled “Collect information, allocate channels” in FIG. 4.

In this embodiment, the mesh network controller 100 may calculate a sum of the multiple RSSIs within the channel scan report from the aforementioned each mesh network agent device, and the mesh network controller 100 may further calculate a sum of the RSSIs within the channel scan report generated by the mesh network controller 100. According to the sums of the RSSIs in respective channel scan reports, the mesh network controller 100 may send corresponding channel selection requests to the mesh network agent devices 110 and 120, respectively, in order to make the mesh network agent devices 110 and 120 select the corresponding wireless communication channel according to the corresponding channel selection requests. More particularly, the mesh network controller 100 may select one of the mesh network controller 100, the mesh network agent device 110 and the mesh network agent device 120 to serve as the topology center device according to the sums of the RSSIs within the respective channel scan reports mentioned above. For better illustration, assume that the mesh network agent device 110 is selected as the topology center device, and the mesh network controller 100 sends a channel selection request SelReq1 to the mesh network agent device 110.

In step S450, the mesh network agent device 110 may select an optimized channel from the multiple candidate channels as the communication channel (e.g., the channel used by the network agent device 110 on the front-haul network) in response to channel selection request SelReq1, and generate a channel selection report OpRep1 according to the optimized channel. For example, the network agent device 110 may scan the multiple candidate channels in response to the channel selection request SelReq1, in order to select the candidate channel with the strongest signal strength from the multiple candidate channels as the optimized channel.

In step S460, the mesh network controller 100 may receive the channel selection report OpRep1 from the mesh network agent device 110, and send a channel selection request SelReq2 to the mesh network agent devices other than the topology center devices (e.g. the mesh network agent device 120) according to the channel selection report OpRep1, in order to make the mesh network agent device 120 and the mesh network controller 100 select channels other than the optimized channel from the candidate channels, making the mesh network controller 100 and the mesh network agent devices 110 and 120 utilize different channels on the front-haul network.

In this embodiment, the topology center device is an AP device with the greatest sum of the RSSIs among the mesh network controller 100 and the mesh network agent devices 110 and 120. For example, when the mesh network agent device 110 is located at the topology center of the mesh network 10, the mesh network agent device 110 may have the greatest sum of the RSSIs. Thus, the mesh network controller 100 may select the mesh network agent device 110 as the topology center device.

In some embodiments, the mesh network controller 100 or the mesh network agent device 120 may be located at the topology center of the mesh network 10, where associated operations of selecting the mesh network controller 100 or the mesh network agent device 120 as the topology center device may be deduced by analogy according to the condition of selecting the mesh network agent device 110 as the topology center device, and are therefore omitted here for brevity. In addition, the number of the mesh network agent devices in the mesh network 10 is not limited to the number shown in FIG. 1 or FIG. 4. Those skilled in this art can understand implementation details for different numbers of mesh network agent devices according to the above descriptions, and related details are omitted here for brevity.

In some embodiments, data transmission among the mesh network controller 100 and the mesh network agent devices 110 and 120 (e.g. the data transmission of the backhaul network mentioned above) may be executed by a wired network (e.g. Ethernet or optical fiber network), and the front-haul network mentioned above may be implemented by a Wi-Fi network, where the operation of detecting the wireless communication information (e.g. scanning the current status of the front-haul network in the air and the current status of the surrounding front-haul networks) refers to detecting wireless communication information of the Wi-Fi network. In some embodiments, both the front-haul network and the backhaul network in the mesh network 10 may be implemented by wireless networks, where the wireless network may comprise multiple frequency bands. For example, the data transmission among the mesh network controller 100 and the mesh network agent devices 110 and 120 (e.g. the data transmission of the backhaul network mentioned above) may be executed by a first frequency band of the wireless network (e.g. a 5-GHz frequency band of the Wi-Fi network), and the front-haul network mentioned above may be executed by a second frequency band of the wireless network (e.g. a 2.4-GHz frequency band of the Wi-Fi network), where the mesh network agent devices 110 and 120 may detect wireless communication information of the 2.4-GHz frequency band of the Wi-Fi network in response to the channel scan request ScanReq, in order to generate the channel scan reports ScanRep1 and ScanRep2, respectively.

Furthermore, when the environment of the mesh network 10 changes, Steps S420 to Step S460 may be re-executed. For example, when an additional mesh network agent device is added into the mesh network 10, the mesh network controller 100 may send the channel scan request ScanReq to all mesh network agent devices in the mesh network 10 again (including the additional mesh network agent device mentioned above), in order to re-allocate the corresponding wireless communication channels for the mesh network agent devices 110 and 120 and the additional mesh network agent device. In another example, when any mesh network agent device of the multiple mesh network agent devices (e.g. any of the mesh network agent devices 110 and 120) of the mesh network 10 is removed from the mesh network 10, the mesh network controller 100 may send the channel scanning request ScanReq to remaining mesh network agent devices in the mesh network 10 again, in order to re-allocate the corresponding wireless communication channels for the remaining mesh network agent devices within the mesh network 10. In some embodiments, when inter-channel interferences or channel loads within the mesh network 10 increase, the mesh network 10 may send the channel scan request ScanReq again, in order to trigger re-execution of Steps S420 to Step S460. In some embodiments, the user may set the mesh network controller 100 to periodically trigger automatic channel selection for the AP devices in the mesh network 10, for example, periodically sending the channel scan request ScanReq to periodically execute Steps S420 to Step S460.

In some embodiments, when the number of the AP devices in the mesh network 10 is small and environmental interference is not complex, the second scan operation of the AP devices (e.g. the channel scan operation performed by the mesh network agent devices 110 in Step S450) may be omitted. In some embodiments, the user may manually disable the second scan operation of the AP devices mentioned above, in order to save time for auto-setting of the mesh network 10.

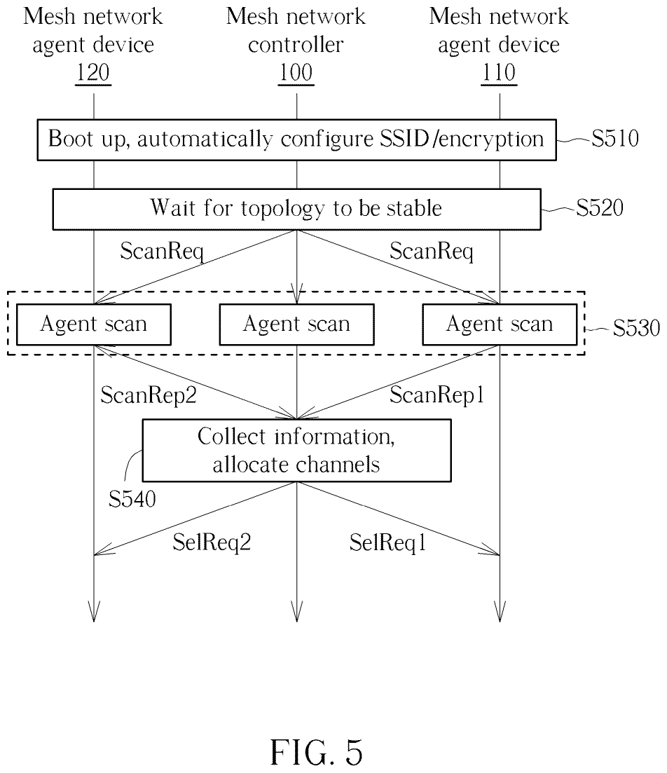

FIG. 5 is a diagram illustrating related details of the method shown in FIG. 3 according to another embodiment of the present invention. In comparison with the embodiment of FIG. 4, the second scan operation of the AP points is omitted in the embodiment of FIG. 5. The operations of Step S510 to Step S530 shown in FIG. 5 are identical to that of Step S410 to Step S430, and are therefore omitted here for brevity.

In Step S540, the mesh network controller 100 may receive the channel scan reports ScanRep1 and ScanRep2 from the mesh network agent devices 110 and 120, respectively, in order to collect information detected by respective AP devices, thereby determining which channels are available (e.g. determining the multiple candidate channels). The difference between Step S540 and Step S440 is that the mesh network controller 100 in Step S540 may determine channels to be utilized by the mesh network controller 100 and the mesh network agent devices 110 and 120 on the front-haul network according to the channel scan reports ScanRep1 and ScanRep2 and the channel scan report generated by the mesh network controller 100. More particularly, the mesh network controller 100 may carry channel information to be allocated to the mesh network agent device 110 on the channel selection request SelReq1, and carry channel information to be allocated to the mesh network agent device 120 on the channel selection request SelReq2, allowing the mesh network agent devices 110 and 120 to select corresponding channels in response to the channel selection requests SelReq1 and SelReq2 from the mesh network controller 100, respectively.

The embodiments of the present invention provide a method, a mesh network controller and a mesh network agent device (more particularly, the mesh network agent devices capable of executing operations of the topology center device), which can perform channel selection according to scan results, making respective AP devices in the mesh network select appropriate channels (e.g. ensuring that all channels of respective APs have sufficiently good quality and are less likely to interfere with others). As the channels utilized by respective APs on the front-haul network in the mesh network can be spaced apart and do not need to share the same channel, overall transmission efficiency can be effectively improved. Furthermore, the embodiments of the present invention will not significantly increase additional costs. Thus, the present invention can solve the problems of the related art without introducing any side effect or in a way that is less likely to introduce side effects.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing channel allocation in a mesh network, the mesh network comprising a mesh network controller and multiple mesh network agent devices, the method comprising:
utilizing the mesh network controller to send a channel scan request to the multiple mesh network agent devices;
utilizing the multiple mesh network agent devices to detect wireless communication information in response to the channel scan request in order to generate multiple channel scan reports, respectively;
utilizing the mesh network controller to receive the multiple channel scan reports from the multiple mesh network agent devices, respectively; and
utilizing the mesh network controller to send corresponding channel selection requests to the multiple mesh network agent devices according to the multiple channel scan reports, in order to make the multiple mesh network agent devices select corresponding wireless communication channels according to the corresponding channel selection requests, respectively.

2. The method of claim 1, wherein the channel scan report generated by each mesh network agent device of the multiple mesh network agent devices comprises received signal strength indicator (RSSI) information.

3. The method of claim 2, wherein the RSSI information comprise multiple RSSIs, and the multiple RSSIs comprise RSSIs between said each mesh network agent device and the other mesh network agent devices and an RSSI between said each mesh network agent device and the mesh network controller.

4. The method of claim 2, wherein the step of utilizing the mesh network controller to send the corresponding channel selection requests to the multiple mesh network agent devices according to the multiple channel scan reports in order to make the multiple mesh network agent devices select the corresponding wireless communication channels according to the corresponding channel selection requests comprises:
utilizing the mesh network controller to calculate a sum of the multiple RSSIs within the channel scan report from said each mesh network agent device; and
utilizing the mesh network controller to send the corresponding channel selection requests to the multiple mesh network agent devices according to the sum, in order to make the multiple mesh network agent devices select the corresponding wireless communication channels according to the corresponding channel selection requests, respectively.

5. The method of claim 4, wherein the step of utilizing the mesh network controller to send the corresponding channel selection requests to the multiple mesh network agent devices according to the sum in order to make the multiple mesh network agent devices select the corresponding wireless communication channels according to the corresponding channel selection requests comprises:
utilizing the mesh network controller to select one of the mesh network controller and the multiple mesh network agent devices as a topology center device according to the sum;
utilizing the mesh network controller to send a first channel selection request of the corresponding channel selection requests to the topology center device;
utilizing the topology center device to select an optimized channel from multiple candidate channels as a wireless communication channel of the topology center device in response to the first channel selection request, and generating a channel selection report according to the optimized channel; and
utilizing the mesh network controller to receive the channel selection report from the topology center device to send a second channel selection request of the corresponding channel selection requests to the multiple mesh network agent devices other than the topology center device according to the channel selection report, in order to make the multiple mesh network agent devices other than the topology center device select channels other than the optimized channel from the multiple candidate channels.

6. The method of claim 5, wherein the topology center device is a mesh network agent device which has a maximum RSSI sum among the multiple mesh network agent devices.

7. The method of claim 1, wherein data transmission between the mesh network controller and the multiple mesh network agent devices is executed by a wired network.

8. The method of claim 1, wherein data transmission between the mesh network controller and the multiple mesh network agent devices is executed by a first frequency band of a wireless network, and the step of utilizing the multiple mesh network agent devices to detect the wireless communication information in response to the channel scan request in order to generate the multiple channel scan reports comprises:
utilizing the multiple mesh network agent devices to detect the wireless communication information of a second frequency band of the wireless network in response to the channel scan request, in order to generate the multiple channel scan reports, respectively.

9. The method of claim 1, further comprising:
in response to an additional mesh network agent device being added into the mesh network, utilizing the mesh network controller to send the channel scan request again, in order to re-allocate the corresponding wireless communication channels for the multiple mesh network agent devices and the additional mesh network agent device.

10. The method of claim 1, further comprising:
in response to any mesh network agent device of the multiple mesh network agent devices being removed, utilizing the mesh network controller to send the channel scan request again, in order to re-allocate the corresponding wireless communication channels for remaining mesh network agent devices within the mesh network.

11. A mesh network controller for performing channel allocation in a mesh network, wherein the mesh network comprises the mesh network controller and multiple mesh network agent devices, and the mesh network controller comprises:
a read only memory (ROM), configured to store a program code;
a processing circuit, coupled to the ROM, configured to execute a channel selection procedure of the mesh network according to the program code, wherein the channel selection procedure comprises:
the processing circuit sends a channel scan request to the multiple mesh network agent devices, wherein the multiple mesh network agent devices detects wireless communication information in response to the channel scan request in order to generate multiple channel scan reports, respectively;
the processing circuit receives the multiple channel scan reports from the multiple mesh network agent devices, respectively; and
the processing circuit sends corresponding channel selection requests to the multiple mesh network agent devices according to the multiple channel scan reports, in order to make the multiple mesh network agent devices select corresponding wireless communication channels according to the corresponding channel selection requests, respectively.

12. The mesh network controller of claim 11, wherein the channel scan report generated by each mesh network agent device of the multiple mesh network agent devices comprises received signal strength indicator (RSSI) information.

13. The mesh network controller of claim 12, wherein the RSSI information comprise multiple RSSIs, and the multiple RSSIs comprise RSSIs between said each mesh network agent device and the other mesh network agent devices and an RSSI between said each mesh network agent device and the mesh network controller.

14. The mesh network controller of claim 12, wherein the processing circuit calculates a sum of the multiple RSSIs within the channel scan report from said each mesh network agent device, and sends the corresponding channel selection requests to the multiple mesh network agent devices according to the sum, in order to make the multiple mesh network agent devices select the corresponding wireless communication channels according to the corresponding channel selection requests, respectively.

15. The mesh network controller of claim 14, wherein the processing circuit selects one of the mesh network controller and the multiple mesh network agent devices as a topology center device according to the sum, the processing circuit sends a first channel selection request of the corresponding channel selection requests to the topology center device, the topology center device selects an optimized channel from multiple candidate channels as a wireless communication channel of the topology center device in response to the first channel selection request and generates a channel selection report according to the optimized channel, and the processing circuit receives the channel selection report from the topology center device to send a second channel selection request of the corresponding channel selection requests to the multiple mesh network agent devices other than the topology center device according to the channel selection report, in order to make the multiple mesh network agent devices other than the topology center device select channels other than the optimized channel from the multiple candidate channels.

16. The mesh network controller of claim 15, wherein the topology center device is a mesh network agent device which has a maximum RSSI sum among the multiple mesh network agent devices.

17. The mesh network controller of claim 11, wherein data transmission between the mesh network controller and the multiple mesh network agent devices is executed by a wired network.

18. The mesh network controller of claim 11, wherein data transmission between the mesh network controller and the multiple mesh network agent devices is executed by a first frequency band of a wireless network, and the multiple mesh network agent devices detect the wireless communication information of a second frequency band of the wireless network in response to the channel scan request, in order to generate the multiple channel scan reports, respectively.

19. A topology center device for performing channel allocation in a mesh network, wherein the mesh network comprises a mesh network controller and multiple mesh network agent devices, the topology center device is one of the multiple mesh network agent devices, and the topology center device comprises:
a read only memory (ROM), configured to store a program code;
a processing circuit, coupled to the ROM, configured to execute a channel selection procedure of the mesh network according to the program code, wherein the channel selection procedure comprises:
the processing circuit receives a channel scan request from the mesh network controller, and detects wireless communication information in response to the channel scan request in order to generate a channel scan report, wherein when the mesh network controller determines that the topology center device is located at a topology center of the mesh network according to the channel scan report from the topology center device, the mesh network controller sends a first channel selection request to the topology center device; and
the processing circuit selects an optimized channel from multiple candidate channels as a wireless communication channel of the topology center device in response to the first channel selection request, and generates a channel selection report according to the optimized channel, wherein the mesh network controller receives the channel selection report from the topology center device to send a second channel selection request to the multiple mesh network agent devices other than the topology center device according to the channel selection report, in order to make the multiple mesh network agent devices other than the topology center device select channels other than the optimized channel from the multiple candidate channels.

20. The topology center device of claim 19, wherein the channel scan report generated by the processing circuit comprises received signal strength indicator (RSSI) information.
